(19) United States
(12) Patent Application Publication
(10) Pub. No.: US 2019/0070927 A1
(43) Pub. Date: Mar. 7, 2019

(54) AIR CONDITIONING SYSTEM

(71) Applicant: Mahle International GmbH, Stuffgart (DE)

(72) Inventor: Rainer Knoeller, Jettingen (DE)

(21) Appl. No.: 16/120,289

(22) Filed: Sep. 2, 2018

(30) Foreign Application Priority Data
Sep. 4, 2017 (DE) 102017215470.5

(51) Int. Cl. B60H 1/00

(52) U.S. Cl. CPC B60H 1/00849

(57) ABSTRACT

An air conditioning system for air conditioning a vehicle interior may include a duct system through which air flows during operation, a conveying device for conveying air through the duct system and into the vehicle interior, and a sensor arranged in a duct section of the duct system. The sensor may measure at least one component of air during operation. The air conditioning system may also include a blocking element for varying a flow of air through the duct section. The blocking element may be adjustable between an open position, in which the blocking element maximizes a flow cross-section through the duct section, and an end position, in which the blocking element clears a predetermined minimum flow cross-section of the duct section, such that the sensor is acted upon by air during operation in all positions of the blocking element.

### CROSS-REFERENCE TO RELATED APPLICATIONS

This application claims priority to German Patent Application No. DE 10 2017 215 470.5, filed on Sep. 4, 2017, the contents of which are hereby incorporated by reference in its entirety.

### TECHNICAL FIELD

The present invention relates to an air conditioning system for air conditioning a vehicle interior. The invention further relates to a vehicle having a vehicle interior and an air conditioning system for air conditioning the vehicle interior.

### BACKGROUND

A vehicle having a generic air conditioning system is known from DE 10 2006 038 711 A1. The air conditioning system comprises a duct system in which, during operation, air flows through and which is fluidically connected to a vehicle interior of the vehicle such that air is supplied to the vehicle interior for air conditioning. A temperature sensor is arranged in a recirculating air duct of the duct system which serves to recirculate air from the vehicle interior. The recirculating air duct is assigned to a flap which controls the flow of air through the recirculating air duct, wherein the flap ensures a minimum opening to the recirculating air duct, so that air always flows through the recirculating air duct and the temperature sensor during operation of the air conditioning system.

### SUMMARY

The present invention is concerned with the task of specifying improved or at least alternative embodiments for an air conditioning system of the type previously mentioned and for a vehicle having such an air conditioning system, which embodiments are characterized in particular by a more precise operation of the air conditioning system.

This object is achieved by the subject matter of the independent claim(s). Advantageous embodiments are the subject matter of the dependent claim(s).

The present invention is based on the general idea of providing a sensor for measuring at least a component of air in a duct system of an air conditioning system for air conditioning a vehicle interior, and assigning a blocking element to the section of the duct system in which the sensor is arranged, which blocking element varies the flow of air through said section and thus the action upon the sensor by air, wherein the blocking element allows at least a minimum flow of air to the sensor at all positions, so that the at least one component of air can always be measured with the sensor. Thus, it is possible with the sensor to always measure the at least one component of the air at different flow rates of the duct system and consequently to adjust the operation of the air conditioning system as needed, so that the operation of the air conditioning system is totally precise. According to the idea of the invention, the air conditioning system has the duct system through which air flows during operation. The air conditioning system further has a conveying device, which conveys air during operation through the duct system and supplies the vehicle interior for air conditioning of the vehicle interior. According to the invention, said sensor is arranged in a duct section of the duct system, which sensor measures at least one component of air during operation. The blocking element for varying the flow of air through the duct section is adjustable between an open position and an end position, wherein the blocking element in the open position maximizes a flow cross-section through the duct section and thus action upon the sensor by air, whereas the blocking element in the end position clears a predetermined minimum flow cross-section of the duct section and thus also minimally acts upon the sensor by air in the end position. As a result, the sensor is acted upon by air during operation in all positions of the blocking element, so that the sensor can measure the at least one component of air in all positions of the blocking element.

The duct system advantageously has a recirculating air duct, which serves to recirculate air from the vehicle interior. It is furthermore advantageous when the duct system has an outer air duct for the admission of outside air into the air conditioning system, that is, from the surroundings into the air conditioning system or into the duct system.

It is conceivable that the recirculating air duct has the duct section in which the sensor is arranged. In particular, the recirculating air duct can form the duct section. With the sensor arranged in the recirculating air duct, it is possible to measure at least a component of air from the vehicle interior.

Alternatively, the outer air duct may have the duct section in which the sensor is arranged. In particular, the outer air duct can form the duct section. With the sensor arranged in the outer air duct, it is possible, in particular, to measure at least one component of air from the surroundings of the air conditioning system or of outside air.

Of course, the air conditioning system can also have a plurality of such duct sections, wherein a sensor for measuring at least one component of air is arranged in the respective duct section and a blocking element of said type is assigned to the respective sensor. This means, in particular, that the recirculating air duct has a duct section in which a sensor is arranged and the outer air duct a further duct section in which a further sensor is arranged, wherein an associated blocking element is assigned to the respective sensor or duct section.

Also conceivable are variants in which such a blocking element is assigned to two or more such duct sections or sensors. The blocking element thus acts as a multi-way blocking element, with which it is possible to vary the flow of air through different duct sections.

The respective blocking element is advantageously arranged upstream of the conveying device. Thus, the conveyance of air through other sections of the duct system is not influenced or is only slightly influenced, in particular not reduced or only slightly reduced.

It is also conceivable to arrange the respective blocking element downstream of the associated sensor. An improved action upon the sensor by air is thus achieved in the end position. In addition, in the end position of the blocking element, the admixture of air flowing through the associated duct section to the air in other sections of the duct system is minimized or at least reduced.

The respective blocking element can in principle be designed arbitrarily. It is conceivable to configure the blocking element as a valve.

Preferably, the respective blocking element is configured as a flap which is worked between the end position and the open position, in particular pivoted. The respective blocking element can thus be implemented inexpensively and easily.

Any component of air can be measured with the respective sensor. It is conceivable to configure the sensor as a particle sensor with which particles of the air, in particular their number and/or density, are measured. The particle sensor is configured, in particular, as a particulate matter sensor with which particulate matter of the air, in particular their number and/or density, are measured.

It is also conceivable to configure the sensor as an air humidity sensor with which, in particular, the water or vapor component in the air is measured.

Variants may also be thought of in which the sensor is configured as an aerosol sensor. It is also conceivable to configure the sensor as a gas sensor for measuring gaseous components of the air, for example, as an oxygen sensor, nitrogen oxide sensor, carbon oxide sensor and the like.

Of course, it is also possible to provide a plurality of such sensors, in particular, in different duct sections. It is also conceivable to provide a sensor in which several types of sensors of the aforementioned type are combined.

It is understood that in addition to the scope of this invention including the air conditioning system and a vehicle having such an air conditioning system, the scope includes a vehicle interior, which is air conditioned with the air conditioning system.

Other important features and advantages of the invention are apparent from the dependent claims, from the drawings and from the associated figure description with reference to the drawings.

It is understood that the features mentioned above and those yet to be explained below can be used not only in the particular given combination, but also in other combinations or in isolation, without departing from the scope of the present invention.

Preferred embodiments of the invention are illustrated in the drawings and will be explained in more detail in the following description, wherein like reference numerals refer to the same or similar or functionally identical components.

### BRIEF DESCRIPTION OF THE DRAWINGS

They show, in each case schematically,

FIG. 1 a highly simplified, schematic diagram of a vehicle having an air conditioning system having a duct system and a blocking element,

FIG. 2 a section through the duct system in the region of the blocking element in a first position of the blocking element,

FIG. 3 the view of FIG. 2 at a second position of the blocking element.

### DETAILED DESCRIPTION

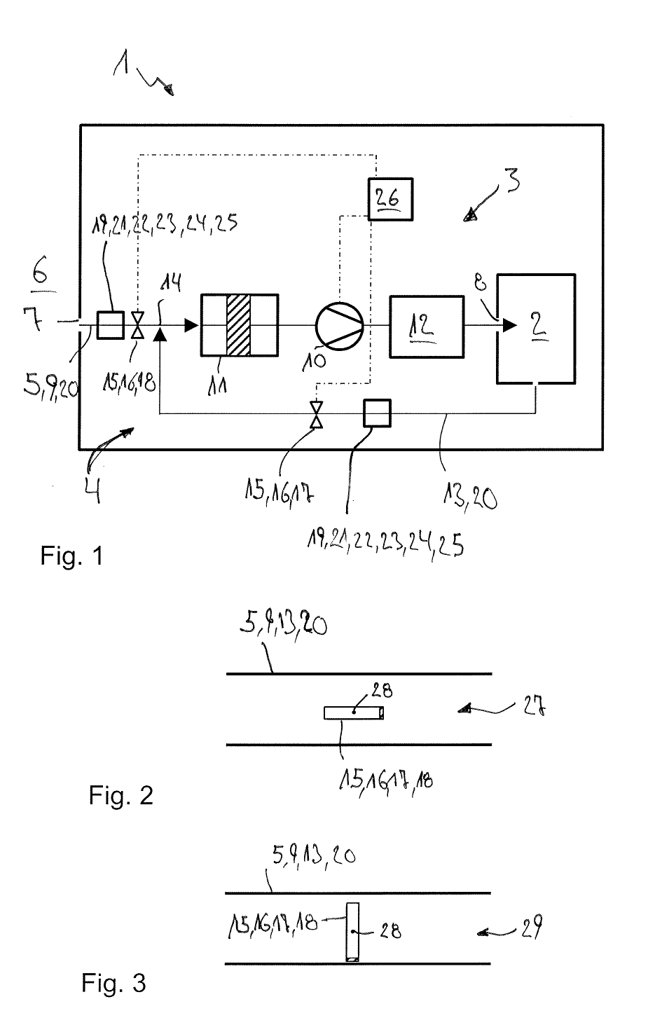

A vehicle 1, as can be seen in FIG. 1, has a vehicle interior 2 for occupants, not shown, of the vehicle 1. The vehicle interior 2 is air conditioned by means of an air conditioning system 3, which supplies air to the vehicle interior 2 for air conditioning. For this purpose, the air conditioning system 3 has a duct system 4 through which air flows during operation. In the example shown, the duct system 4 has an outer air duct 5 for the admission of air from surroundings 6 of the air conditioning system 3 or of the vehicle 2 and thus of outside air into the air conditioning system 3 or into the duct system 4. In the example shown, the outer air duct 5 runs from an inlet opening 7, through which outside air enters the outer air duct 5, up to an outlet opening 8, through which air is guided into the vehicle interior 2, and is also referred to below as the main duct 9. A conveying device 10 of the air conditioning system 3 is arranged in the main duct 9, which conveying device conveys air during operation through the duct system 4 and supplies the vehicle interior 2. A filter device 11 for filtering the air is arranged in the main duct 9 upstream of the conveying device 10. At least one heat exchanger 12 is arranged in the main duct 9 downstream of the conveying device 10. It is possible to change the air temperature and/or air humidity and thus to air condition the air with the at least one heat exchanger 12. The duct system 4 further has a 13 for recirculating air from the vehicle interior 2, which recirculating air duct runs from the vehicle interior 2 to an inlet point 14 in the main duct 9, wherein the inlet point 14 is arranged upstream of the filter device 11. A blocking element 15 is arranged in the recirculating air duct 13, which blocking element is configured as a flap 16 and is also referred to below as a recirculating air flap 17. A blocking element 15 is arranged in the outer air duct 5 or in the main duct 9 upstream of the inlet point 14, which blocking element is configured as a flap 16 and is also referred to below as an outer air flap 18. It is possible to influence the flow of air through the associated duct 5, 13 with the respective blocking element 15. This means that with the blocking element 15 arranged in the recirculating air duct 13, the flow of air through the recirculating air duct 13 is influenced and with the blocking element 15 arranged in the outer air duct 9, the flow of air through the outer air duct 5 is influenced.

As can be seen in FIG. 1, a sensor 19 is arranged in the recirculating air duct 13 upstream of the blocking element 15 or the recirculating air flap 17. In this case, the recirculating air duct 13 forms a duct section 20 of the duct system 4 in which the sensor 19 is arranged. In the example shown, a further sensor 19 is also arranged upstream of the blocking element 15 in the outer air duct 5, in particular the outer air flap 18. The outer air duct 5 thus has a further duct section 20 of the duct system 4 in which the sensor 19 is arranged. It is possible to measure at least one component of air with the respective sensor 19. The sensor 19 is therefore configured in particular as an aerosol sensor 21, as a particle sensor 22, in particular as a particulate matter sensor 23, as an air humidity sensor 24 or as a gas sensor 25. It is also conceivable to configure at least one of the sensors 19 through a combination of said sensor types 21-25.

In addition, a control device 26 is provided which may be part of the air conditioning system 3 and/or the vehicle 1. It is possible to control the air conditioning system 3 with the control device 26. In this case, the control device 26 is connected to the respective blocking element 15 and the conveying device 10 such that the control device 26 controls them during operation.

The respective blocking element 15 is, as shown in FIGS. 2 and 3, designed such that it always allows a flow through the associated duct section 20, so that the associated sensor 19 is always acted upon by air.

In FIG. 2, an open position 27 of the flap 16 configured as a blocking element 15, that is, the recirculating air flap 17 or the outer air flap 18 can be seen, which is pivotable about a pivot axis 28. In the open position 27, the blocking element 15 maximizes a flow cross-section through the associated duct section 20, that is, in the present case through the outer air duct 5 or the recirculating air duct 13.

In FIG. 3, the blocking element 5 is adjusted by pivoting about the pivot axis 28 in an end position 29, in which the blocking element 15 only clears a predetermined minimum flow cross-section of the duct section 2. As a result, the sensor 19 arranged in the duct section 20 is acted upon by air in all positions of the blocking element 15, so that the sensor 19 can measure the at least one component of air during operation in all positions of the blocking element 15.

1. An air conditioning system for air conditioning a vehicle interior comprising:
a duct system through which air flows during operation;
a conveying device for conveying air through the duct system and into the vehicle interior;
a sensor arranged in a duct section of the duct system, the sensor measuring at least one component of air during operation; and
a blocking element for varying a flow of air through the duct section, the blocking element adjustable between an open position, in which the blocking element maximizes a flow cross-section through the duct section and an end position, in which the blocking element clears a predetermined minimum flow cross-section of the duct section, such that the sensor is acted upon by air during operation in all positions of the blocking element.

2. The air conditioning system according to claim 1, wherein the duct system includes a recirculating air duct for recirculating air from the vehicle interior, the recirculating air duct including the duct section in which the sensor is arranged.

3. The air conditioning system according to claim 1, wherein the duct system includes an outer air duct for admitting outside air into the air conditioning system, the outer air duct including the duct section in which the sensor is arranged.

4. The air conditioning system according to claim 1, wherein the blocking element is arranged upstream of the conveying device.

5. The air conditioning system according to claim 1, wherein the blocking element is arranged downstream of the sensor.

6. The air conditioning system according to claim 1, wherein the blocking element is structured as a flap.

7. The air conditioning system according to claim 1, wherein the sensor is a particle sensor.

8. The air conditioning system according to claim 1, wherein the sensor is an air humidity sensor.

9. The air conditioning system according to claim 1, wherein the sensor is an aerosol sensor.

10. A vehicle comprising a vehicle interior and an air conditioning system for air conditioning the vehicle interior, the air conditioning system including:
a duct system through which air flows during operation;
a conveying device for conveying air through the duct system and into the vehicle interior;
a sensor arranged in a duct section of the duct system, the sensor measuring at least one component of air during operation; and
a blocking element for varying a flow of air through the duct section, the blocking element adjustable between an open position, in which the blocking element maximizes a flow cross-section through the duct section, and an end position, in which the blocking element clears a predetermined minimum flow cross-section of the duct section, such that the sensor is acted upon by air during operation in all positions of the blocking element.

11. The vehicle according to claim 10, wherein the duct system includes a recirculating air duct for recirculating air from the vehicle interior, the recirculating air duct including the duct section in which the sensor is arranged.

12. The vehicle according to claim 10, wherein the duct system includes an outer air duct for admitting outside air into the air conditioning system, the outer air duct including the duct section in which the sensor is arranged.

13. The vehicle according to claim 10, wherein the blocking element is arranged upstream of the conveying device.

14. The vehicle according to claim 10, wherein the blocking element is arranged downstream of the sensor.

15. The vehicle according to claim 10, wherein the blocking element is structured as a flap.

16. The vehicle according to claim 10, wherein the sensor is one of i) a particle sensor, ii) an air humidity sensor, and iii) an aerosol sensor.

17. The air conditioning system according to claim 7, wherein the sensor is a particulate matter sensor.

18. An air conditioning system for air conditioning a vehicle interior comprising:
a duct system through which air is flowable including a recirculating air duct and an outer air duct, the recirculating air duct structured and arranged to recirculate air from the vehicle interior, the outer air duct structured and arranged to admit outside air into the air conditioning system;
a conveying device configured to convey air through the duct system and into the vehicle interior;
a sensor configured to measure at least one component of air, the sensor arranged in a duct section of the duct system; and
a blocking element configured to vary a flow of air through the duct section, the blocking element adjustable to an open position and an end position, a flow cross-section of the duct section having a maximum area when the blocking element is in the open position, the flow cross-section having a minimum area when the blocking element is in the end position;
wherein air acts on the sensor during operation regardless of a position of the blocking element.

19. The air conditioning system according to claim 18, wherein the blocking element is arranged upstream of the conveying device and downstream of the sensor.

20. The air conditioning system according to claim 19, wherein:
the blocking element is structured as a flap; and
the sensor is one of i) a particle sensor, ii) an air humidity sensor, and iii) an aerosol sensor.
